(19) United States
(12) Patent Application Publication
(10) Pub. No.: US 2026/0238926 A1
(43) Pub. Date: Aug. 13, 2026

(54) SOUND GENERATING UNIT AND SOUND GENERATING MODULE

(71) Applicant: GOERTEK INC., Weifang, Shandong (CN)

(72) Inventors: Xiaodong CAI, Weifang, Shandong (CN); Song LIU, Weifang, Shandong (CN); Bobo LI, Weifang, Shandong (CN)

(21) Appl. No.: 19/496,830

(22) PCT Filed: Feb. 21, 2025
(86) PCT No.: PCT/CN2025/078425

§ 371 Date: Dec. 23, 2025

(30) Foreign Application Priority Data
Jun. 27, 2024 (CN) 202421498535.1

(51) Int. Cl. H04R 9/04; H04R 1/02; H04R 1/06; H04R 7/04; H04R 7/18; H04R 9/02; H04R 9/06

(52) U.S. Cl. CPC H04R 9/046; H04R 1/023; H04R 1/025; H04R 1/06; H04R 7/04; H04R 7/18; H04R 9/025; H04R 9/043; H04R 9/06

(57) ABSTRACT

Disclosed is a sound generating unit including a housing, a magnetic circuit unit, and a vibration unit, wherein the magnetic circuit unit is accommodated in the housing, the magnetic circuit unit includes a first magnetic assembly and a second magnetic assembly spaced apart in a first direction; the vibration unit is positioned between the first magnetic assembly and the second magnetic assembly, the vibration unit includes a diaphragm and a voice coil connected to the diaphragm, the diaphragm includes a vibrating plate and a surround arranged around the vibrating plate, the voice coil includes a first voice coil portion and a second voice coil portion that are located on opposite sides of the vibrating plate in the first direction, the first voice coil portion is located in a first magnetic gap, and the second voice coil portion is located in a second magnetic gap.

### TECHNICAL FIELD

The present disclosure relates to the field of electroacoustic technologies, and in particular, to a sound generating unit and a sound generating module.

### DESCRIPTION OF RELATED ART

With the improvement of people's living standards, intelligent electronic devices are increasingly popular among users. At present, the development of intelligent electronic devices tends to be light and thin, but the requirements for acoustic performance of electronic devices with sound generating requirements, such as speaker products, are also increasing. However, in existing speaker products, an effective vibration area of a speaker unit is generally limited, the sensitivity is poor, and the Mid-frequency performance of the product is affected, resulting in poor Mid-frequency performance. In addition, because a magnetic circuit unit of the speaker unit is usually located on one side of a vibration unit, the magnetic field distribution in the vibration area of the voice coil is non-uniform, and a distortion risk is relatively high.

### SUMMARY

A main purpose of the present disclosure is to provide a sound generating unit and a sound generating module, aiming to solve the technical problems of poor sensitivity, poor Mid-frequency performance and high distortion risk of speaker products in related art.

In order to achieve the above purpose, the present disclosure provides a sound generating unit, including:
a housing having an accommodating space and a sound outlet in communication with the accommodating space;
a magnetic circuit unit accommodated in the accommodating space, wherein the magnetic circuit unit includes a first magnetic assembly and a second magnetic assembly spaced apart in a first direction, the first magnetic assembly has a first magnetic gap, the second magnetic assembly has a second magnetic gap, and the first magnetic gap and the second magnetic gap are arranged opposite to each other in the first direction; and
a vibration unit positioned between the first magnetic assembly and the second magnetic assembly, wherein the vibration unit includes a diaphragm and a voice coil connected to the diaphragm, the diaphragm includes a vibrating plate and a surround arranged around the vibrating plate, the voice coil includes a first voice coil portion and a second voice coil portion that are located on opposite sides of the vibrating plate in the first direction, the first voice coil portion is located in the first magnetic gap, and the second voice coil portion is located in the second magnetic gap.

In an embodiment, the first voice coil portion and the second voice coil portion are wound from a same wire, and the vibrating plate includes an inner vibrating plate connected to an inner wall of the voice coil and an outer vibrating plate connected to an outer wall of the voice coil.

In an embodiment, the surround includes a plurality of bending portions arranged in the first direction and sequentially connected, ends of two outermost bending portions in the first direction respectively form a first end and a second end, the first end is connected to the vibrating plate, the second end is connected to the housing or the second magnetic assembly, and sound generated from a side of the vibrating plate facing the first magnetic assembly radiates to the outside through the sound outlet.

In an embodiment, the first end is connected to the side of the vibrating plate facing the second magnetic assembly, and the second end is disposed around the second magnetic assembly.

In an embodiment, a contour size of a projection of the second end in the first direction is greater than a contour size of a projection of the first end in the first direction.

In an embodiment, a contour of a projection of an outer edge of the vibrating plate in the first direction is located outside a contour of a projection of the second magnetic assembly in the first direction.

In an embodiment, the contour of the projection of the outer edge of the vibrating plate in the first direction is located outside a contour of a projection of the first magnetic circuit assembly in the first direction.

In an embodiment, a position of the vibrating plate close to the outer edge of the vibrating plate bends and extends in a direction close to the first magnetic assembly to form a slope structure, and the first magnetic assembly is provided with a position clearance portion for avoiding the slope structure.

In an embodiment, the surround includes a first connection portion, a deformation portion, and a second connection portion that are sequentially connected. In an embodiment, an arrangement direction of the first connection portion, the deformation portion, and the second connection portion is perpendicular to the first direction, the first connection portion is connected to the vibrating plate, and the second connection portion is connected to the housing.

In an embodiment, the first magnetic assembly includes a first inner magnet and a first outer magnet disposed around the first inner magnet, the first inner magnet and the first outer magnet are spaced apart and form the first magnetic gap therebetween, the second magnetic assembly includes a second inner magnet and a second outer magnet disposed around the second inner magnet, and the second inner magnet and the second outer magnet are spaced apart and form the second magnetic gap therebetween.

In an embodiment, the first inner magnet and the second inner magnet are magnetized in opposite directions, the first outer magnet and the second outer magnet are magnetized in opposite directions, and the first inner magnet and the first outer magnet are magnetized in opposite directions.

In an embodiment, the first magnetic gap and the second magnetic gap are aligned in the first direction.

In an embodiment, the first outer magnet is an annular magnet.

In an embodiment, the first inner magnet is arranged opposite to the second inner magnet, and the first outer magnet is arranged opposite to the second outer magnet.

In an embodiment, the sound generating unit further includes a spider, the spider is disposed at an end of the second voice coil portion away from the diaphragm, the spider includes an inner fixing portion, an elastic arm portion, and an outer fixing portion that are sequentially connected, the inner fixing portion is connected to the second voice coil portion, the outer fixing portion is connected to the housing, the elastic arm portion connects the inner fixing portion and the outer fixing portion, the second magnetic assembly includes a plurality of second outer magnets spaced apart circumferentially around the second inner magnet, and an clearance space for avoiding the elastic arm portion is formed between any two adjacent second outer magnets.

In an embodiment, one side of the second voice coil portion is connected to an external circuit. In an embodiment, the spider is formed of a conductive material, and the second voice coil portion is connected to the external circuit through the spider.

In an embodiment, the housing includes a first housing and a second housing, the first housing and the second housing enclose the accommodating space, the first magnetic assembly is disposed on the first housing, the second magnetic assembly is disposed on the second housing, and the first housing is provided with the sound outlet thereon.

In an embodiment, the first housing includes a bottom plate and a side wall surrounding and being connected to an outer edge of the bottom plate, the side wall is provided with the sound outlet, the second housing is disposed at an end of the side wall that is away from the bottom plate, a plastic bracket is disposed on a side of the second housing that faces the accommodating space, the plastic bracket is disposed around the second magnetic assembly, and the surround is connected to the plastic bracket. In an embodiment, the second housing includes a top plate and a side wall, the side wall is provided with the sound outlet, the first housing is disposed at an end of the side wall that is away from the top plate, a plastic bracket is disposed on a side of the top plate that faces the accommodating space, the plastic bracket is disposed around the second magnetic assembly, and the second connection end is connected to the plastic bracket.

In an embodiment the plastic bracket is connected to the second housing or the first housing.

In an embodiment, the plastic bracket and the second housing are integrally injection-molded. In an embodiment, a conductive member is embedded on the plastic bracket.

In an embodiment, the first housing is made of metal material.

In an embodiment, the second housing is made of metal material.

In an embodiment, the second housing is made of magnetically permeable material.

In an embodiment, the second housing is provided with a pressure equalization vent (sound vent) communicating the accommodating space with an external environment and a protective mesh covering the sound vent.

In an embodiment, the inner vibrating plate has a magnetically permeable portion.

In an embodiment, the inner vibrating plate is a magnetically permeable plate to form the magnetically permeable portion.

In an embodiment, a magnetically permeable member is embedded inside the inner vibrating plate to form the magnetically permeable portion.

In an embodiment, a magnetically permeable member is disposed on at least one side of the inner vibrating plate in the first direction to form the magnetically permeable portion.

In an embodiment, at least one surface of the inner vibrating plate in the first direction is coated with a magnetically permeable material to form the magnetically permeable portion.

The present disclosure also provides a sound generating module, including a module case and the sound generating unit as described above. In an embodiment, the module case has an accommodating cavity, and the sound generating unit is accommodated in the accommodating cavity.

According to the present disclosure, in the sound generating unit, the magnetic circuit unit includes a first magnetic assembly and a second magnetic assembly arranged at intervals in the first direction, the first magnetic assembly and the second magnetic assembly respectively have a first magnetic gap and a second magnetic gap; the vibration unit is positioned between the first magnetic assembly and the second magnetic assembly; and the voice coil of the diaphragm unit includes a first voice coil portion located in the first magnetic gap and a second voice coil portion located in the second magnetic gap, which realizes design in which both the magnetic circuit unit and the vibration unit are symmetrically disposed on opposite sides of the sound generating unit, so that the magnetic field distribution of the vibration area of the voice coil is uniform, which can ensure a large and relatively flat driving force for the voice coil with the change of displacement, thereby reducing the risk of distortion. Meanwhile, the first voice coil portion and the second voice coil portion are wound from the same wire, which facilitates the winding and assembly of the voice coil, and facilitates the electrical connection between the voice coil and an external circuit.

### BRIEF DESCRIPTION OF DRAWINGS

In order to more clearly illustrate the embodiments of the present application or the technical solutions in the related art, the drawings required to be used for the content of the embodiments or the prior art will be briefly introduced in the following. Obviously, the drawings in the following description are merely a part of the drawings of the present application, and for those of ordinary skill in the art, other drawings can also be obtained from the provided drawings without any creative effort.

FIG. 1 is an assembly schematic diagram illustrating a sound generating unit according to an embodiment of the present disclosure.

FIG. 2 is a schematic cross-sectional view of a sound generating unit according to an embodiment of the present disclosure.

FIG. 3 is a schematic exploded schematic view of a sound generating unit according to an embodiment of the present disclosure.

FIG. 4 is another schematic exploded schematic view of the sound generating unit according to an embodiment of the present disclosure.

FIG. 5 is a schematic diagram illustrating magnetic field distribution of a sound generating unit according to an embodiment of the present disclosure.

FIG. 6 is a schematic diagram illustrating a BL(x) curve of a sound generating unit according to an embodiment of the present disclosure.

FIG. 7 is a schematic diagram illustrating magnetization directions of a sound generating unit according to an embodiment of the present disclosure.

FIG. 8 is a schematic exploded schematic view of a sound generating unit according to another embodiment of the present disclosure.

FIG. 9 is a schematic structural diagram in which a magnetically permeable member is embedded inside an inner vibrating plate in a sound generating unit according to an embodiment of the present disclosure.

FIG. 10 is a schematic structural diagram in which a magnetically permeable member is disposed on a lower side of an inner vibrating plate in a sound generating unit according to an embodiment of the present disclosure.

FIG. 11 is a schematic structural diagram in which a magnetically permeable member is disposed on an upper side of an inner vibrating plate in a sound generating unit according to an embodiment of the present disclosure.

FIG. 12 is a schematic cross-sectional view of a sound generating module according to an embodiment of the present disclosure.

FIG. 13 is an exploded schematic view of the sound generating module in FIG. 12.

FIG. 14 is a schematic cross-sectional view of a sound generating module according to another embodiment of the present disclosure.

FIG. 15 is an exploded schematic view of the sound generating module in FIG. 14.

FIG. 16 is a schematic cross-sectional view of a sound generating unit according to another embodiment of the present disclosure.

### DESCRIPTION OF REFERENCE NUMERALS

100: sound generating unit; 10: housing; 11: accommodating space; 12: first housing; 121: bottom plate; 13: second housing; 131: top plate; 14: side wall; 15: plastic bracket; 151: conductive member; 16: sound outlet; 17: sound vent; 18: protective mesh; 20: magnetic circuit unit; 21: first magnetic assembly; 211: first magnetic gap; 212: first inner magnet; 213: first outer magnet; 214: clearance portion; 22: second magnetic assembly; 221: second magnetic gap; 222: second inner magnet; 223: second outer magnet; 224: clearance space; 30: vibration unit; 31: diaphragm; 311: vibrating plate; 3111: inner vibrating plate; 3112: outer vibrating plate; 3113: magnetically permeable portion; 3114: slope structure; 312: surround; 3121: first end; 3122: second end; 3123: bending portion; 3124: first extension portion; 3125: second extension portion; 32: voice coil; 321: first voice coil portion; 322: second voice coil portion; 40: spider; 41: inner fixing portion; 42: elastic arm portion; 43: outer fixing portion; 200: sound generating module; 50: module case; 51: accommodating cavity; 511: front cavity; 512: rear cavity; 52: first case; 53: second case; 54: sound outlet; 55: support wall; 56: opening; 57: filling port; 58: damper.

The realization of the purpose, functional characteristics and advantages of the present disclosure will be described with reference to the embodiments and the accompanying drawings.

### DETAILED DESCRIPTIONS

The following clearly describes the technical solutions in the embodiments of the present disclosure with reference to the accompanying drawings in the embodiments of the present disclosure, and obviously, the described embodiments are only a part of the embodiments of the present disclosure, but not all the embodiments. Based on the embodiments of the present disclosure, all other embodiments obtained by those skilled in the art without creative efforts fall within the protection scope of the present disclosure.

It should be noted that all directional indications (such as up, down, left, right, front, and rear) in the embodiments of the present disclosure are merely used to explain a relative position relationship and a movement condition and the like between components in a specific posture (as shown in the accompanying drawings), and if the specific posture changes, the directional indication changes accordingly.

In addition, in the embodiments of the present disclosure, descriptions such as “first”, “second” and the like are merely used for description purposes, and cannot be understood as indicating or implying relative importance thereof or implicitly indicating a quantity of indicated technical features. Thus, a feature defining with “first” and “second” may explicitly or implicitly include at least one of the features. In addition, the technical solutions among the various embodiments may be combined with each other, but must be based on the fact that the technical solutions can be realized by those of ordinary skill in the art, and when the combination of the technical solutions contradicts or cannot be realized, it should be considered that the combination of the technical solutions does not exist or fall within the protection scope claimed by the present disclosure.

With the improvement of people's living standards, intelligent electronic devices are increasingly popular among users. At present, the development of intelligent electronic devices tends to be light and thin, but the requirements for acoustic performance of electronic devices with sound generating requirements, such as speaker products, are also increasing. However, in existing speaker products, an effective vibration area of a speaker unit is generally limited, the sensitivity is poor, and the Mid-frequency performance of the product is affected, resulting in poor Mid-frequency performance. In addition, because a magnetic circuit unit of the speaker unit is usually located on one side of a vibration unit, the magnetic field distribution in the vibration area of the voice coil is non-uniform, and the risk of distortion is relatively high.

In view of this, it is necessary to provide a sound generating unit and a sound generating module to solve or at least alleviate the above-mentioned technical problem.

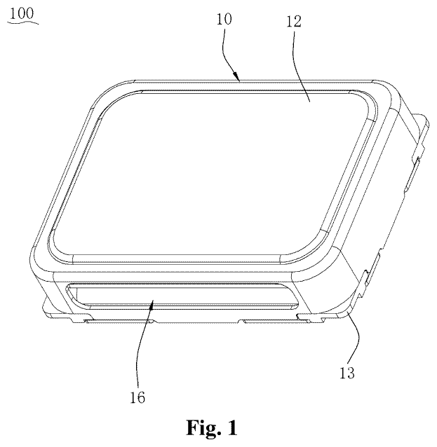

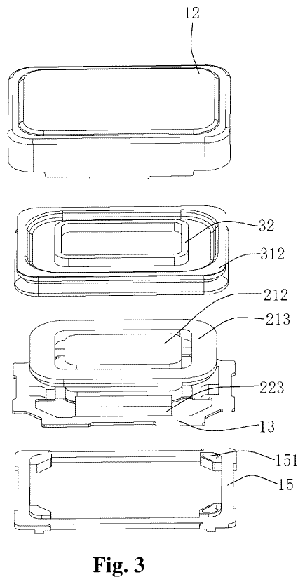

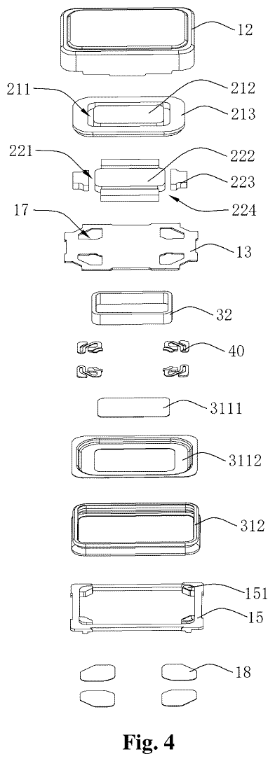

As shown in FIG. 1 to FIG. 4, the present disclosure provides a sound generating unit 100, the sound generating unit 100 includes a housing 10, a magnetic circuit unit 20 and a vibration unit 30. In an embodiment, the housing 10 has an accommodating space 11 and a sound outlet 16 communicating with the accommodating space 11, the magnetic circuit unit 20 is accommodated in the accommodating space 11, the magnetic circuit unit 20 includes a first magnetic assembly 21 and a second magnetic assembly 22 arranged at intervals in a first direction, the first magnetic assembly 21 has a first magnetic gap 211, and the second magnetic assembly 22 has a second magnetic gap 221; the vibration unit 30 is positioned between the first magnetic assembly 21 and the second magnetic assembly 22, sound emitted from the vibration unit 30 radiates to the outside through the sound outlet 16, the vibration unit 30 includes a diaphragm 31 and a voice coil 32 connected to the diaphragm 31, the diaphragm 31 includes a vibrating plate 311 and a surround 312 arranged around the vibrating plate 311, the voice coil 32 includes a first voice coil portion 321 and a second voice coil portion 322 located on opposite sides of the vibrating plate 311 in the first direction, the first voice coil portion 321 is located in the first magnetic gap 211, and the second voice coil portion 322 is located in the second magnetic gap 221. In an embodiment, the first voice coil portion 321 and the second voice coil portion 322 are wound from a same wire, and the vibrating plate 311 includes an inner vibrating plate 3111 connected to an inner wall of the voice coil 32 and an outer vibrating plate 3112 connected to an outer wall of the voice coil 32.

The sound generating unit 100 of the present disclosure may be a micro speaker unit, the sound generating unit 100 may be applied to a sound generating module 200 of an electronic device, and the electronic device may be a computer, a mobile phone, a smart wearable device, etc. In this embodiment, the sound generating unit 100 is illustrated by taking a micro speaker unit as an example.

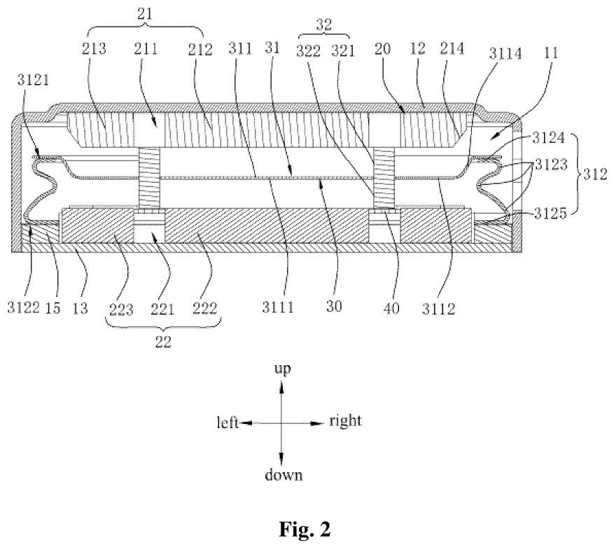

A first direction is the vertical direction in FIG. 2, and the vertical direction is the up-and-down direction. A second direction is a horizontal direction shown in FIG. 2, and the horizontal direction is the left-and-right direction. The first direction is perpendicular to the second direction.

In an embodiment, the magnetic circuit unit 20 and the vibration unit 30 are both accommodated in the accommodating space 11 of the housing 10, and the structure is compact. The magnetic circuit unit 20 includes a first magnetic assembly 21 and a second magnetic assembly 22, the first magnetic assembly 21 and the second magnetic assembly 22 are arranged at intervals in the up-and-down direction, and the vibration unit 30 is positioned between the first magnetic assembly 21 and the second magnetic assembly 22, that is, the upper and lower sides of the vibration unit 30 are respectively provided with the first magnetic assembly 21 and the second magnetic assembly 22. The first magnetic assembly 21 and the second magnetic assembly 22 provide a driving force for the voice coil 32, so that the voice coil 32 vibrates in the first direction, thereby driving the diaphragm 31 to vibrate in the first direction, to implement vibration and sound emitting.

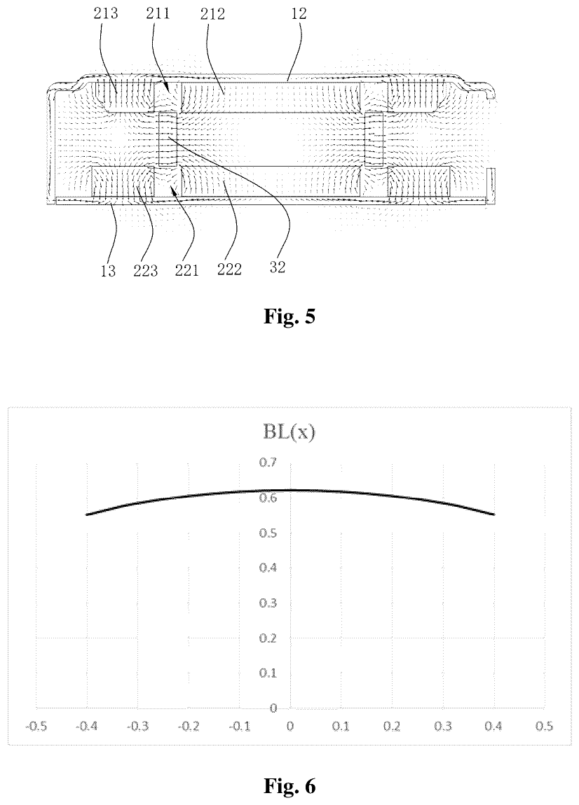

As shown in FIG. 2 to FIG. 5, in the sound generating unit 100 of the present disclosure, the magnetic circuit unit 20 includes the first magnetic assembly 21 and the second magnetic assembly 22 respectively arranged on the upper side and the lower side of the vibration unit 30, and the voice coil 32 includes the first voice coil portion 321 located in the first magnetic gap 211 and the second voice coil portion 322 located in the second magnetic gap 221, thereby realizing a design in which both the magnetic circuit unit 20 and the vibration unit 30 are symmetrically disposed on opposite sides of the sound generating unit 100, so that the magnetic field distribution of the vibration region of the voice coil 32 is uniform, which can provide the voice coil 32 with a large and relatively flat driving force with the change of displacement, as shown by the BL(x) curve shown in FIG. 6, the BL curve is substantially symmetrical in the left-and-right direction, and the BL at the Xmax position (i.e., the maximum displacement of the voice coil 32) is attenuated by less than 10% relative to the BL at the rest position, thereby realizing a ultra-linear BL(x) design and reducing the risk of distortion. It can be understood that the horizontal axis shown in FIG. 6 represents displacement in mm, and the vertical axis represents BL in Wb/m. Meanwhile, the first voice coil portion 321 and the second voice coil portion 322 are wound from the same wire, which facilitates the winding and assembly of the voice coil 32, and facilitates the electrical connection between the voice coil 32 and an external circuit.

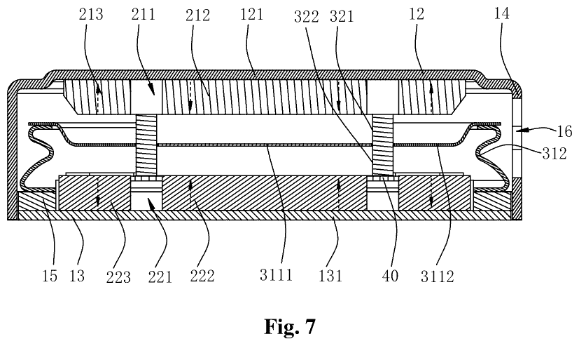

As shown in FIG. 7, in an embodiment, the first voice coil portion 321 and the second voice coil portion 322 are wound from the same wire, and the vibrating plate 311 includes an inner vibrating plate 3111 connected to the inner wall of the voice coil 32 and an outer vibrating plate 3112 connected to the outer wall of the voice coil 32. In this embodiment, the first voice coil portion 321 and the second voice coil portion 322 are of an integrated design and are wound from the same wire, that is, the voice coil 32 is of a straight cylindrical shape and is of a single voice coil 32 design. The vibrating plate 311 is separated by the voice coil 32 into the inner vibrating plate 3111 and the outer vibrating plate 3112, the inner vibrating plate 3111 is connected to the inner wall of the voice coil 32, and the outer vibrating plate 3112 is connected to the outer wall of the voice coil 32, to implement assembly of the voice coil 32 and the diaphragm 31.

In another embodiment, the first voice coil portion 321 and the second voice coil portion 322 are wound from the same wire, the vibrating plate 311 includes an inner vibrating plate 3111 connected to the inner wall of the voice coil 32 and an outer vibrating plate 3112 connected to the outer wall of the voice coil 32, and one side of the second voice coil portion 322 is connected to an external circuit. In this embodiment, the first voice coil portion 321 and the second voice coil portion 322 are integrally designed, are wound from the same wire, and are designed as a single voice coil 32. The vibrating plate 311 is separated by the voice coil 32 into the inner vibrating plate 3111 and the outer vibrating plate 3112, the inner vibrating plate 3111 is connected to an inner wall of the voice coil 32, and the outer vibrating plate 3112 is connected to an outer wall of the voice coil 32, to implement assembly of the voice coil 32 and the diaphragm 31. In addition, one side of the second voice coil portion 322 is connected to an external circuit, to implement an electrical connection between the voice coil 32 and the external circuit.

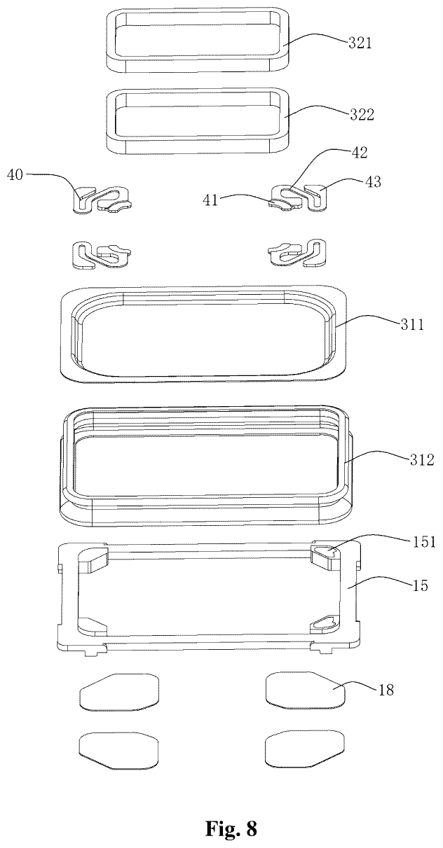

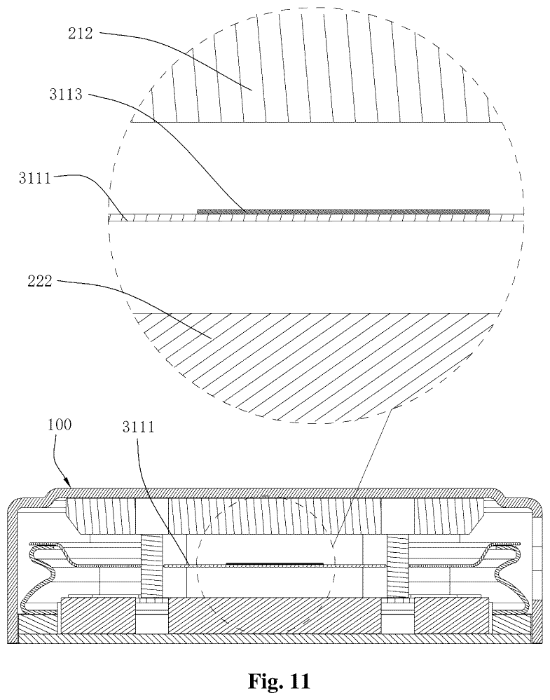

As shown in FIG. 2 to FIG. 4 and FIG. 7 to FIG. 12, in an embodiment, two ends of the surround 312 in the up-and-down direction are a first end 3121 and a second end 3122, respectively. In an embodiment, the first end 3121 is connected to the vibrating plate 311, the second end 3122 is connected to the housing 10 or the second magnetic assembly 22, the first end 3121 and the first magnetic assembly 21 are arranged on the same side, and the second end 3122 and the second magnetic assembly 22 are arranged on the same side, so that the surround 312 has a certain height in the vertical direction, that is, the surround 312 is a vertical surround 312 extending in the vertical direction, thereby expanding the size of the vibrating plate 311 in a width direction of the sound generating unit 100, improving the effective vibration area (SD) of the sound generating unit 100, improving the sensitivity of the sound generating unit 100, improving the Mid-frequency performance of the product, and optimizing the Mid-frequency performance of the product.

Specifically, the surround 312 includes a plurality of bending portions 3123 sequentially connected in the first direction, each bending portion 3123 is bent toward the second direction, and bending directions of any two adjacent bending portions 3123 are opposite, so that the surround 312 forms a wave-shaped structure, two of the bending portions 3123 located at the outermost sides in the first direction respectively form a first end 3121 and a second end 3122, the first end 3121 is connected to the vibrating plate 311, the second end 3122 is connected to the housing 10 or the second magnetic assembly 22, and sound generated from a side of the vibrating plate 311 facing the first magnetic assembly 21 radiates to the outside through the sound outlet 16.

Specifically, the surround 312 includes a plurality of bending portions 3123 sequentially connected in the up-and-down direction, each bending portion 3123 is bent toward the horizontal direction, and the bending directions of any two adjacent bending portions 3123 are opposite, so that the surround 312 forms a wave-shaped structure, two of the bending portions 3123 located at the outermost sides in the first direction respectively form a first end 3121 and a second end 3122, that is, the bending portion 3123 located at the uppermost side and the bending portion 3123 located at the lowermost side respectively form the first end 3121 and the second end 3122. The surround 312 is designed as a wave-shaped structure that is arranged in the vertical direction and bent multiple times in the horizontal direction, which improves the compliance of the surround 312, thereby expanding the size of the vibrating plate 311 in the width direction of the sound generating unit 100, increasing the effective vibration area of the sound generating unit 100 to a greater extent, thereby improving the sensitivity of the sound generating unit 100 and optimizing the Mid-frequency performance.

Each bending portion 3123 is an arc-shaped bending portion 3123, and any two adjacent bending portions 3123 are smoothly transitionally connected, which improves the smooth compliance of the surround 312, avoids stress concentration, and is more conducive to improving the compliance of the surround 312.

As shown in FIG. 2, in an embodiment, the first end 3121 extends in the second direction to form a first extension portion 3124, and the first extension portion 3124 is stacked on and connected to the vibrating plate 311. The first end 3121 extends in the horizontal direction to form the first extension portion 3124, and the first extension portion 3124 is stacked on and connected to the bottom of the vibrating plate 311, thereby improving the assembly stability of the surround 312 and the vibrating plate 311.

The second end 3122 extends in the second direction to form a second extension portion 3125, and the second extension portion 3125 is stacked on and connected to the housing 10 or the second magnetic assembly 22. The second end 3122 extends in the horizontal direction to form the second extension portion 3125, and the second extension portion 3125 is stacked on and connected to the top of the housing 10 or the top or bottom of the second magnetic assembly 22, to correspondingly improve assembly stability of the surround 312 and the housing 10 or the second magnetic assembly 22.

In another embodiment, the second end 3122 sequentially extends in the second direction and the first direction to form a second extension portion 3125, that is, the second end 3122 first extends in the horizontal direction and then extends in the up-and-down direction to form the second extension portion 3125, and the second extension portion 3125 is connected to a side of the housing 10 to improve the assembly stability between the surround 312 and the housing 10.

In the present disclosure, the surround 312 and the housing 10 or the second magnetic assembly 22 in the sound generating unit 100 may be connected in various manners.

As shown in FIG. 2, the number of the bending portions 3123 is three, namely, a first bending portion, a second bending portion and a third bending portion. The first bending portion, the second bending portion and the third bending portion are sequentially connected in the first direction, one end of the first bending portion away from the second bending portion forms a first end 3121, and one end of the third bending portion away from the second bending portion forms a second end 3122. The surround 312 includes three bending portions 3123, and the number of the bending portions 3123 may be appropriately selected, so as to fully extend the surround 312 while saving the space occupied by the surround 312.

In an embodiment, the surround 312 is connected to a side of the vibrating plate 311 facing the second magnetic assembly 22, and the second end 3122 is disposed around the second magnetic assembly 22. As shown in FIG. 2, the surround 312 is connected to the side of the vibrating plate 311 facing the second magnetic assembly 22, that is, the surround 312 is connected to the lower side of the vibrating plate 311, and the second end 3122 surrounds an outer side of the second magnetic assembly 22, so that the structural design is reasonable.

In an embodiment, a contour size of the projection of the second end 3122 in the first direction is greater than a contour size of the projection of the first end 3121 in the first direction, that is, the second end 3122 is projected in the vertical direction, and a contour size of the projection on a horizontal plane is greater than a contour size of the projection of the first end 3121 on the horizontal plane. The first end 3121 and the second end 3122 are both provided in a ring shape, which increases the outer contour size of the second end 3122 relative to the first end 3121, thereby improving the ability of increasing the outer contour size of the surround 312, thereby improving the effective vibration area of the sound generating unit 100 and improving the mechanical compliance of the surround 312.

In an embodiment, a contour of the projection of the outer edge of the vibrating plate 311 in the first direction is located outside a contour of the projection of the second magnetic assembly 22 in the first direction, that is, the contour of the projection of the outer edge of the vibrating plate 311 on the horizontal plane is located outside the contour of the projection of the second magnetic assembly 22 on the horizontal plane, so that the size of the vibrating plate 311 is large, and the effective vibration area of the sound generating unit 100 is improved.

In an embodiment, a contour of the projection of the outer edge of the vibrating plate 311 in the first direction is located outside a contour of the projection of the first magnetic assembly 21 in the first direction, that is, the contour of the outer edge of the vibrating plate 311 projected on the horizontal plane is located outside the contour of the first magnetic assembly 21 projected on the horizontal plane, so that the size of the vibrating plate 311 is large, and the effective vibration area of the sound generating unit 100 is improved.

In an embodiment, a position of the vibrating plate 311 close to the outer edge of the vibrating plate 311 is bent and extends in a direction close to the first magnetic assembly 21 to form a slope structure 3114, and the first magnetic assembly 21 is provided with a position clearance portion for avoiding the slope structure 3114. As shown in FIG. 2, the vibrating plate 311 is bent and extends upward at a position close to the outer edge of the vibrating plate 311 to form a slope structure 3114, which facilitates increasing the arrangement space of the surround 312, and the clearance portion 214 of the first magnetic assembly 21 can avoid the slope structure 3114 to prevent the first magnetic assembly 21 from interfering with the vibrating plate 311.

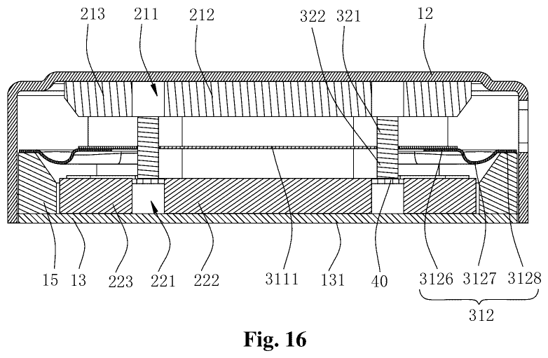

In an embodiment, as shown in FIG. 16, the surround includes a first connection portion, a deformation portion, and a second connection portion that are sequentially connected, an arrangement direction of the first connection portion, the deformation portion, and the second connection portion is perpendicular to the first direction, the first connection portion is connected to the vibrating plate, and the second connection portion is connected to the housing. The surround may be provided in various forms according to actual requirements, which is not limited herein.

In an embodiment, the first magnetic assembly 21 includes a first inner magnet 212 and a first outer magnet 213, the first outer magnet 213 surrounds the first inner magnet 212 and is spaced apart from the first inner magnet 212, a first magnetic gap 211 is formed between the first inner magnet 212 and the first outer magnet 213, and magnetic induction lines passing through the first magnetic gap 211 may be generated between the first inner magnet 212 and the first outer magnet 213, so that the first voice coil portion 321 vibrates in the up-and-down direction to cut the magnetic induction lines when the first voice coil portion 321 is energized. It may be understood that the first inner magnet 212 and the first outer magnet 213 are disposed in the second direction.

The second magnetic assembly 22 includes a second inner magnet 222 and a second outer magnet 223, the second outer magnet 223 surrounds the second inner magnet 222 and is spaced apart from the second inner magnet 222, a second magnetic gap 221 is formed between the second inner magnet 222 and the second outer magnet 223, and magnetic induction lines passing through the second magnetic gap 221 can be generated between the second inner magnet 222 and the second outer magnet 223, so that the second voice coil portion 322 vibrates in the up-and-down direction to cut the magnetic induction lines when the second voice coil portion 322 is energized. It may be understood that the second inner magnet 222 and the second outer magnet 223 are disposed in the second direction.

In an embodiment, as shown in FIG. 7, both the first magnetic assembly 21 and the second magnetic assembly 22 are magnetized in a first direction, the first inner magnet 212 and the second inner magnet 222 are magnetized in opposite directions, the first outer magnet 213 and the second outer magnet 223 are magnetized in opposite directions, and the first inner magnet 212 and the first outer magnet 213 are magnetized in opposite directions. In this way, an annular closed magnetic loop is formed between the magnetic induction lines generated by the first outer magnet 213 and the first inner magnet 212, and an annular closed magnetic loop is also formed between the magnetic induction lines generated by the second outer magnet 223 and the second inner magnet 222, so that the magnetic lines passing through the voice coil 32 are more and denser, and the driving force is larger.

In an embodiment, the first magnetic gap 211 and the second magnetic gap 221 are aligned in the first direction, so that the first voice coil portion 321 and the second voice coil portion 322 respectively located in the first magnetic gap 211 and the second magnetic gap 221 are aligned, thereby improving vibration consistency and avoiding rocking.

In an embodiment, the first outer magnet 213 is an annular magnet, the annular magnet has good continuity, which is conducive to improving the uniformity of magnetic field distribution.

In an embodiment, the first inner magnet 212 and the second inner magnet 222 are arranged opposite to each other, and the first outer magnet 213 and the second outer magnet 223 are arranged opposite to each other, which facilitates the alignment of the first magnetic gap 211 and the second magnetic gap 221, so that the first voice coil portion 321 and the second voice coil portion 322 respectively located in the first magnetic gap 211 and the second magnetic gap 221 are aligned, thereby improving vibration consistency and avoiding rocking.

In an embodiment, a size of the first inner magnet 212 in the second direction is the same as a size of the second inner magnet 222 in the second direction, and a size of the first outer magnet 213 in the second direction is smaller than a size of the second outer magnet 223 in the second direction. Specifically, the shapes of the first inner magnet 212 and the second inner magnet 222 are matched, and a size of the first inner magnet 212 in the horizontal direction is the same as a size of the second inner magnet 222 in the horizontal direction, which is conducive to improving the uniformity of magnetic field distribution; furthermore, a size of the first outer magnet 213 in the horizontal direction is smaller than a size of the second outer magnet 223 in the horizontal direction, that is, a size of the outer edge of the first outer magnet 213 is smaller than a size of the outer edge of the second outer magnet 223; compared to the second outer magnet 223, the outer edge of the first outer magnet 213 is narrowed to avoid interference between the first outer magnet 213 and the diaphragm 31.

In an embodiment, the sound generating unit 100 further includes a spider 40, the spider 40 is disposed at an end of the second voice coil portion 322 away from the diaphragm 31, the spider 40 includes an inner fixing portion 41, an elastic arm portion 42 and an outer fixing portion 43 that are sequentially connected in the second direction, the inner fixing portion 41 is connected to the second voice coil portion 322, the outer fixing portion 43 is connected to the housing 10, the elastic arm portion 42 connects the inner fixing portion 41 and the outer fixing portion 43, the second magnetic assembly 22 includes a plurality of second outer magnets 223, the plurality of second outer magnets 223 are spaced apart in the circumferential direction of the second inner magnet 222, and an clearance space 224 for avoiding the elastic arm portion 42 is formed between any two adjacent second outer magnets 223.

As shown in FIG. 2 and FIG. 7, the spider 40 is arranged at a bottom end of the second voice coil portion 322, and the spider 40 includes an inner fixing portion 41, an elastic arm portion 42 and an outer fixing portion 43. In an embodiment, the inner fixing portion 41, the elastic arm portion 42 and the outer fixing portion 43 are sequentially connected from inside to outside in the horizontal direction, the outer fixing portion 43 is connected to the housing 10, the inner fixing portion 41 is connected to the second voice coil portion 322, the elastic arm portion 42 connects the inner fixing portion 41 and the outer fixing portion 43, and the elastic arm portion 42 is elastic, so that the inner fixing portion 41 can vibrate with the second voice coil portion 322. The spider 40 centers and supports the voice coil 32, prevents the voice coil 32 from rocking/tilting (or lateral deflection), and improves the vibration stability of the voice coil 32.

Preferably, the spider 40 is formed of a conductive material, namely a conductive spider 40, and the second voice coil portion 322 is connected to an external circuit through the spider 40, thereby achieving an electrical connection between the second voice coil portion 322 and the external circuit. In addition, the spider 40 may be conductive, other conductive members 151 may be omitted, the integration degree is high, and the structure is simplified.

In an embodiment, the inner vibrating plate 3111 has a magnetically permeable portion 3113. During the vibration process, due to the action of the magnetically permeable portion 3113, the inner vibrating plate 3111 may be subjected to attraction forces of the first magnetic assembly 21 and the second magnetic assembly 22, specifically, when the inner vibrating plate 3111 vibrates in a direction close to the first magnetic assembly 21, a resultant force of the attraction forces of the first magnetic assembly 21 and the second magnetic assembly 22 on the magnetically permeable portion 3113 is directed to the first magnetic assembly 21, which is conducive to assisting the inner vibrating plate 3111 to vibrate upward, and when the inner vibrating plate 3111 vibrates in a direction close to the second magnetic assembly 22, a resultant force of the attraction forces of the first magnetic assembly 21 and the second magnetic assembly 22 on the magnetically permeable portion 3113 is directed to the second magnetic assembly 22, which is conducive to assisting the inner vibrating plate 3111 to vibrate downward. Therefore, the design of the magnetically permeable portion 3113 can assist the vibration of the inner vibrating plate 3111 and improve the sound generating effect.

In an embodiment, the inner vibrating plate 3111 is a magnetically permeable plate to form a magnetically permeable portion 3113, that is, the inner vibrating plate 3111 itself is a magnetically permeable plate with magnetic conductivity to form the magnetically permeable portion 3113 without additionally providing other magnetically permeable portions 3113, and the structure is simple.

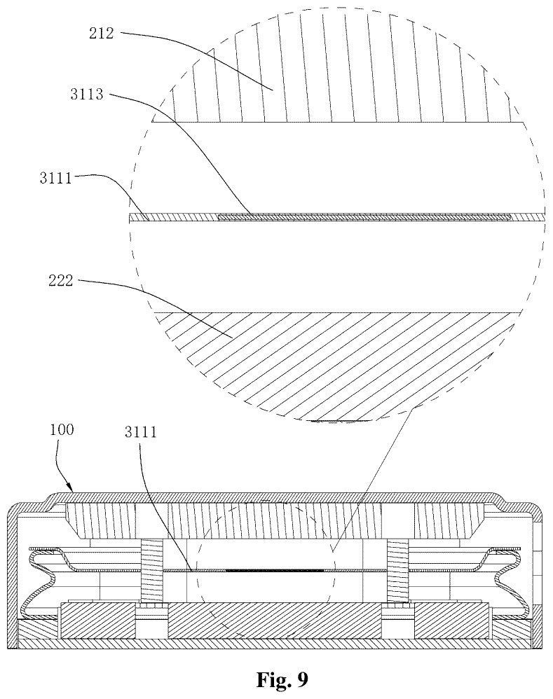

In another embodiment, as shown in FIG. 9, a magnetically permeable member is embedded in the inner vibrating plate 3111 to form a magnetically permeable portion 3113. The magnetically permeable member is embedded in the inner vibrating plate 3111, so that the structure is consistent and compact.

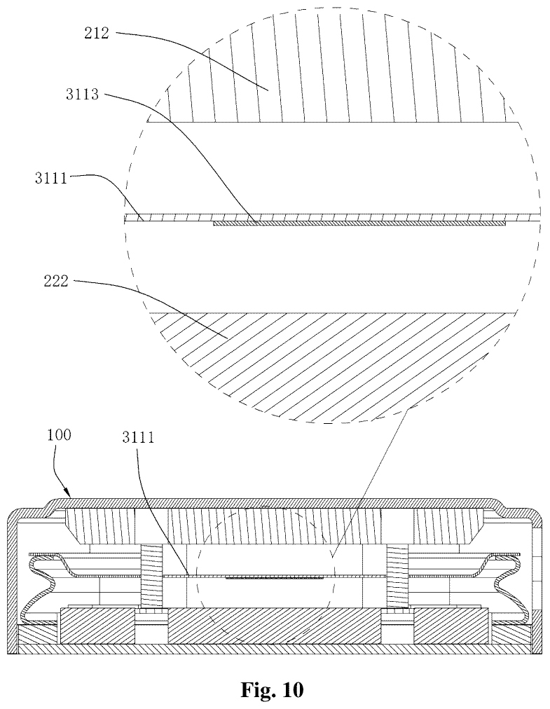

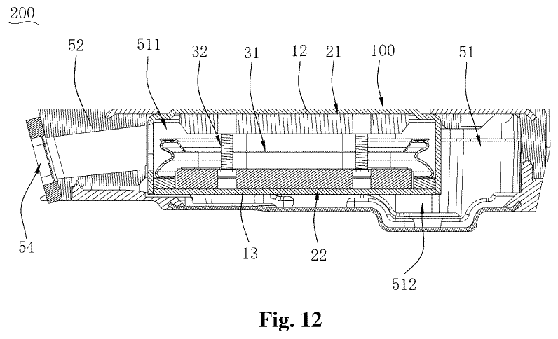

In another embodiment, at least one side of the inner vibrating plate 3111 in the first direction is provided with a magnetically permeable member to form a magnetically permeable portion 3113. For example, as shown in FIG. 12, a magnetically permeable member is disposed on an upper side of the inner vibrating plate 3111. For another example, as shown in FIG. 10, a magnetically permeable member is disposed on a lower side of the inner vibrating plate 3111. For another example, upper and lower sides of the inner vibrating plate 3111 are both provided with magnetically permeable members.

In yet another embodiment, at least one surface of the inner vibrating plate 3111 in the first direction is coated with a magnetically permeable material to form a magnetically permeable portion 3113. For example, an upper surface of the inner vibrating plate 3111 is coated with a magnetically permeable material. For another example, a lower surface of the inner vibrating plate 3111 is coated with a magnetically permeable material. For another example, upper and lower surfaces of the inner vibrating plate 3111 are both coated with a magnetically permeable material.

The formation and position of the magnetically permeable portion 3113 of the present disclosure can be set according to actual requirements, and the setting modes are various and highly flexible.

In the sound generating unit 100 of the present disclosure, the housing 10 includes a first housing 12 and a second housing 13, the first housing 12 and the second housing 13 enclose an accommodating space 11, the first magnetic assembly 21 is disposed on the first housing 12, the second magnetic assembly 22 is disposed on the second housing 13, and the surround 312 is connected to the second housing 13, which has a reasonable structural design and is convenient for assembly. Optionally, the first housing is provided with a sound outlet 16.

In an embodiment, the first housing 12 includes a bottom plate 121 and a side wall 14 surround and connected to the outer edge of the bottom plate 121, the side wall 14 is provided with a sound outlet 16, the second housing 13 is disposed at an end of the side wall 14 away from the bottom plate 121, a plastic bracket 15 is disposed on a side of the second housing 13 facing the accommodating space 11, the plastic bracket 15 is disposed around the second magnetic assembly 22, and the surround 312 is connected to the plastic bracket 15.

It should be noted that, in an orientation as shown in FIG. 2, the first housing 12 is located on an upper side of the second housing 13. However, during actual assembly, the first housing 12 may be in an orientation of being located on a lower side of the second housing 13, and accordingly, as shown in FIG. 2, a bottom plate 121 of the first housing 12 is located on an upper side, and a top plate 131 of the second housing 13 is located on a lower side.

The first housing 12 includes a bottom plate 121 and a side wall 14 surround and connected to the outer edge of the bottom plate 121, and the side wall 14 is provided with a sound outlet 16 to facilitate sound emitting. The second housing 13 is disposed at an end of the side wall 14 away from the bottom plate 121, a plastic bracket 15 is disposed on a side of the second housing 13 facing the accommodating space 11, the plastic bracket 15 is disposed around the second magnetic assembly 22, and the surround 312 is connected to the plastic bracket 15 to implement assembly. In addition, the plastic bracket 15 and the second housing 13 are integrally injection-molded, which is convenient to manufacture and omits assembly steps and assembly errors. The spider 40 may be connected to the plastic bracket 15, specifically, the outer fixing portion 43 of the spider 40 may be connected to the plastic bracket 15, and the plastic bracket 15 is embedded with a conductive member 151 to facilitate an electrical connection to a pad on the spider 40.

In another embodiment, the second housing 13 includes a top plate 131 and a side wall 14, the side wall 14 is provided with a sound outlet 16, and sound generated from the side of the vibrating plate 311 facing the first magnetic assembly 21 radiates to the outside through the sound outlet 16. The first housing 12 is disposed at an end of the side wall 14 away from the top plate 131, a plastic bracket 15 is disposed on a side of the top plate 131 facing the accommodating space 11, the plastic bracket 15 is disposed around the second magnetic assembly 22, and the surround 312 is connected to the plastic bracket 15 to implement assembly. In addition, the plastic bracket 15 and the second housing 13 are integrally injection-molded, which is convenient to manufacture and omits assembly steps and assembly errors. The spider 40 may be connected to the plastic bracket 15, specifically, the outer fixing portion 43 of the spider 40 may be connected to the plastic bracket 15, and the plastic bracket 15 is embedded with a conductive member 151 to facilitate an electrical connection to a pad on the spider 40.

In an embodiment, the first housing 12 is made of metal, which has good durability, high strength, good heat dissipation, and can improve sound quality. The second housing 13 is made of metal, has good durability, high strength, good heat dissipation, and can improve sound quality. The second housing 13 may also be made of a magnetically permeable material and has a magnetically permeable capability, which is conducive to correcting magnetic lines. The second housing 13 is provided with a sound vent 17 communicating the accommodating space 11 with an external environment and a protective mesh 18 covering the sound vent 17, and the sound vent 17 communicates the accommodating space 11 with the external environment, which can balance an internal and external pressure difference and improve the sound quality. The arrangement of the protective mesh 18 avoids leakage of a sound-absorbing material filled in a rear cavity 512 of the accommodating space 11 described later.

As shown in FIG. 12 to FIG. 15, the present disclosure also provides a sound generating module 200, including a module case 50 and the foregoing sound generating unit 100. In an embodiment, the module case 50 has an accommodating cavity 51, and the sound generating unit 100 is accommodated in the accommodating cavity 51, to accommodate the sound generating unit 100. The sound generating module 200 may be a speaker module, and the sound generating module 200 may be applied to electronic devices such as computers, mobile phones, and smart wearables. The specific structure of the sound generating unit 100 in the sound generating module 200 refers to the above embodiments, and since the sound generating module 200 adopts all the technical solutions of all the above embodiments, it has at least all the beneficial effects brought by the technical solutions of the above embodiments, which will not be repeated here.

The sound generating unit 100 separates the accommodating cavity 51 into a front cavity 511 and the rear cavity 512, the front cavity 511 is in communication with the external environment to realize normal sound emission of the sound generating module 200, and the rear cavity 512 is filled with a sound absorbing material to adjust the acoustic performance of the sound generating module 200.

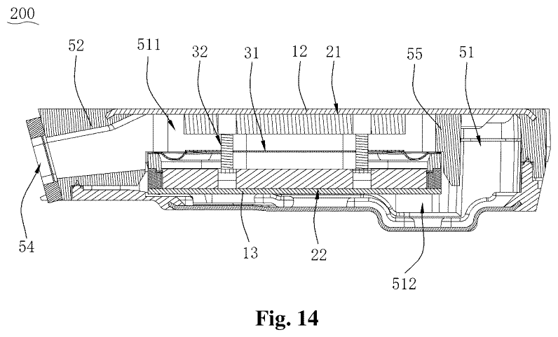

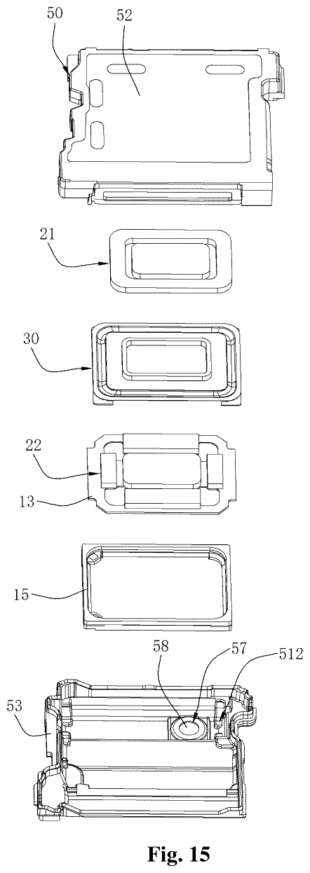

In an embodiment, as shown in FIG. 14 and FIG. 15, the module case 50 includes a first case 52 and a second case 53, the first case 52 and the second case 53 enclose an accommodating cavity 51, the first case 52 is provided with a support wall 55, and the housing 10 is supported on the support wall 55 to improve the mounting stability of the sound generating unit 100 in the accommodating cavity 51. The first magnetic assembly 21 is connected to the first case 52, a front cavity 511 is formed between the vibration unit 30 and the first case 52, and a rear cavity 512 is formed between the vibration unit 30 and the housing 10, the second case 53, and the first case 52, and the structural design is reasonable.

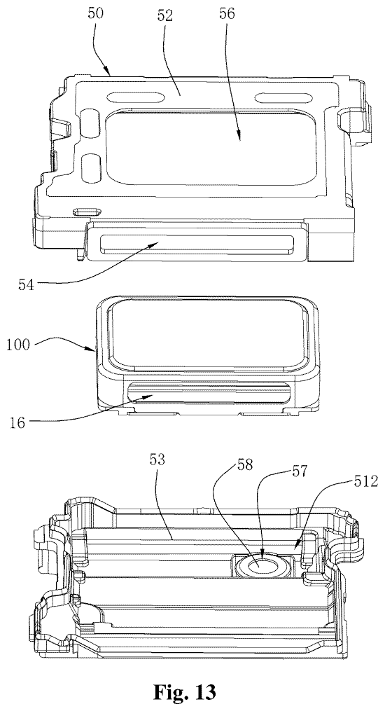

In another embodiment, as shown in FIG. 12 and FIG. 13, the module case 50 includes a first case 52 and a second case 53, the first case 52 and the second case 53 enclose an accommodating cavity 51, the first case 52 is provided with an opening 56, the sound generating unit 100 closes the opening 56, a front cavity 511 is formed between a side of the vibration unit 30 close to the first magnetic assembly 21 and the housing 10 and the first case 52, and a rear cavity 512 is formed between the vibration unit 30 and the housing 10, the second case 53, and the first case 52.

Specifically, in order to realize the light and thin design of the sound generating module 200, the first case 52 is provided with an opening 56, the opening 56 forms a hollow area on the first case 52, and the sound generating unit 100 accommodated in the accommodating cavity 51 can close the opening 56, thereby improving the sealing performance of the sound generating module 200. A front cavity 511 is formed between a side of the vibration unit 30 close to the first magnetic assembly 21 and the housing 10 and the first case 52, and a rear cavity 512 is formed between the vibration unit 30 and the housing 10, the second case 53, and the first case 52, and the structural design is reasonable.

In an embodiment, the rear cavity 512 is filled with a sound absorbing material, the second case 53 is provided with a filling port 57 filled with the sound absorbing material, and the second case 53 is further provided with a damper 58 for covering the filling port 57. The rear cavity 512 is filled with a sound-absorbing material, which can adjust the acoustic performance of the sound generating module 200. The second case 53 is provided with a filling port 57, so that the sound-absorbing material is filled in the rear cavity 512, and after the filling is completed, the damper 58 covers the filling port 57 to avoid leakage of the sound-absorbing material.

The above are only preferred embodiments of the present disclosure, and do not limit the patent scope of the present disclosure, and any equivalent structural transformation made by using the description and drawings of the present disclosure or direct/indirect application in other related technical fields under the inventive concept of the present disclosure is included in the patent protection scope of the present disclosure.

1. A sound generating unit, comprising:
a housing having an accommodating space and a sound outlet in communication with the accommodating space;
a magnetic circuit unit accommodated in the accommodating space, the magnetic circuit unit comprising a first magnetic assembly and a second magnetic assembly spaced apart in a first direction, the first magnetic assembly having a first magnetic gap, the second magnetic assembly having a second magnetic gap, and the first magnetic gap and the second magnetic gap being arranged opposite to each other in the first direction; and
a vibration unit positioned between the first magnetic assembly and the second magnetic assembly, the vibration unit comprising a diaphragm and a voice coil connected to the diaphragm, the diaphragm comprising a vibrating plate and a surround arranged around the vibrating plate, the voice coil comprising a first voice coil portion and a second voice coil portion located on opposite sides of the vibrating plate in the first direction, the first voice coil portion being positioned in the first magnetic gap, and the second voice coil portion being positioned in the second magnetic gap,
wherein the first voice coil portion and the second voice coil portion are wound from a same wire, and the vibrating plate comprises an inner vibrating plate connected to an inner wall of the voice coil and an outer vibrating plate connected to an outer wall of the voice coil.

2. The sound generating unit of claim 1, wherein the surround comprises a plurality of bending portions arranged in the first direction and sequentially connected, two of the bending portions located at outermost sides in the first direction respectively form a first end and a second end, the first end is connected to the vibrating plate, the second end is connected to the housing or the second magnetic assembly, and sound generated from a side of the vibrating plate facing the first magnetic assembly radiates to the outside through the sound outlet.

3. The sound generating unit of claim 2, wherein the first end is connected to the side of the vibrating plate facing the second magnetic assembly, and the second end is disposed around the second magnetic assembly, and/or
wherein a contour size of a projection of the second end in the first direction is greater than a contour size of a projection of the first end in the first direction, and/or
wherein a contour of a projection of an outer edge of the vibrating plate in the first direction is located outside a contour of a projection of the second magnetic circuit assembly in the first direction, and/or
wherein the contour of the projection of the outer edge of the vibrating plate in the first direction is located outside a contour of a projection of the first magnetic assembly in the first direction, and/or
wherein a position of the vibrating plate close to the outer edge of the vibrating plate bends and extends in a direction close to the first magnetic assembly to form a slope structure, and the first magnetic assembly is provided with a position clearance portion for avoiding the slope structure.

4. The sound generating unit of claim 1, wherein the surround comprises a first connection portion, a deformation portion, and a second connection portion sequentially connected, an arrangement direction of the first connection portion, the deformation portion, and the second connection portion is perpendicular to the first direction, the first connection portion is connected to the vibrating plate, and the second connection portion is connected to the housing.

5. The sound generating unit of claim 1, wherein the first magnetic assembly comprises a first inner magnet and a first outer magnet disposed around the first inner magnet, the first inner magnet and the first outer magnet are spaced apart and with the first magnetic gap formed therebetween, the second magnetic assembly comprises a second inner magnet and a second outer magnet disposed around the second inner magnet, and the second inner magnet and the second outer magnet are spaced apart with the second magnetic gap formed therebetween.

6. The sound generating unit of claim 5, wherein magnetizing directions of the first inner magnet and the second inner magnet are opposite, magnetizing directions of the first outer magnet and the second outer magnet are opposite, and the first inner magnet and the first outer magnet are magnetized in opposite directions, and/or
wherein the first magnetic gap and the second magnetic gap are aligned in the first direction, and/or
wherein the first outer magnet is an annular magnet, and/or
wherein the first inner magnet is arranged opposite to the second inner magnet, and the first outer magnet is arranged opposite to the second outer magnet.

7. The sound generating unit of claim 5, wherein the sound generating unit further comprises a spider, the spider is disposed at an end of the second voice coil portion away from the diaphragm, the spider comprises an inner fixing portion, an elastic arm portion, and an outer fixing portion that are sequentially connected, the inner fixing portion is connected to the second voice coil portion, the outer fixing portion is connected to the housing, the elastic arm portion connects the inner fixing portion and the outer fixing portion, the second magnetic assembly comprises a plurality of second outer magnets spaced apart circumferentially around the second inner magnet, and an clearance space is formed between any two adjacent second outer magnets for avoiding the elastic arm portion, and
wherein one side of the second voice coil portion is connected to an external circuit; or the spider is formed of a conductive material, and the second voice coil portion is connected to the external circuit through the spider.

8. The sound generating unit of claim 1, wherein the housing comprises a first housing and a second housing, the first housing and the second housing which jointly define the accommodating space, the first magnetic assembly is disposed on the first housing, the second magnetic assembly is disposed on the second housing, and the sound outlet is provided on the first housing.

9. The sound generating unit of claim 8, wherein the first housing comprises a bottom plate and a side wall surrounding and being connected to an outer edge of the bottom plate, the side wall is provided with the sound outlet, the second housing is disposed at an end of the side wall that is away from the bottom plate, a plastic bracket is disposed on the second housing at a side facing the accommodating space, the plastic bracket is disposed around the second magnetic assembly, and the surround is connected to the plastic bracket; or the second housing comprises a top plate and a side wall, the side wall is provided with the sound outlet, the first housing is disposed on the side wall at an end away from the top plate, a plastic bracket is disposed on the top plate at a side facing the accommodating space, the plastic bracket is disposed around the second magnetic assembly, and the second connection end is connected to the plastic bracket, and
wherein the plastic bracket and the second housing are integrally injection-molded, and/or a conductive member is embedded on the plastic bracket.

10. The sound generating unit of claim 8, wherein the first housing is formed of metal material; and/or
the second housing is formed of metal material; and/or
the second housing is made of magnetically permeable material; and/or
the second housing is provided with a sound vent communicating the accommodating space with an external environment and a protective mesh covering the sound vent.

11. The sound generating unit of claim 1, wherein the inner vibrating plate has a magnetically permeable portion.

12. The sound generating unit of claim 11, wherein the inner vibrating plate is a magnetically permeable plate to form the magnetically permeable portion, or
a magnetically permeable member is embedded inside the inner vibrating plate to form the magnetically permeable portion, or
a magnetically permeable member is disposed on at least one side of the inner vibrating plate in the first direction to form the magnetically permeable portion, or
at least one surface of the inner vibrating plate in the first direction is coated with a magnetically permeable material to form the magnetically permeable portion.

13. A sound generating module, comprising a module case and the sound generating unit according to claim 1.
